(19) United States
(12) Patent Application Publication
(10) Pub. No.: US 2026/0330549 A1
(43) Pub. Date: Oct. 22, 2026

(54) SYSTEMS AND METHODS AND GRAPHICAL USER INTERFACES FOR IMPROVED USER INTERACTION AND ELECTRONIC MESSAGE PROCESSING

(71) Applicant: Intercontinental Exchange Holdings, Inc., Atlanta, GA (US)

(72) Inventors: Marcos Brodsky, New York, NY (US); Peter Borstelmann, Ridgefield, CT (US); Pomeli Ghosh, Edison, NJ (US); Philip Joseph Cenatiempo, JR., Old Bridge, NJ (US); Steve Jaffe, Glen Rock, NJ (US)

(73) Assignee: Intercontinental Exchange Holdings, Inc., Atlanta, GA (US)

(21) Appl. No.: 19/655,167

(22) Filed: Apr. 22, 2026

Related U.S. Application Data
(60) Provisional application No. 63/792,742, filed on Apr. 22, 2025.

(51) Int. Cl. G06Q 40/04

(52) U.S. Cl. CPC G06Q 40/043

(57) ABSTRACT

Systems, methods, and non-transitory computer readable media for electronic transaction processing. A server may: broadcast a predefined period to user devices; display on the user devices first data and user interaction tools for performing a first predefined action; receive a plurality of action indications associated with the first predefined action for a portion of the first data; determine that a characteristic associated with the plurality of action indications and the portion of the first data meet a predetermined condition; accept those among the plurality of action indications that meet the predetermined condition to form second data; display, during a coordination session initiated at a completion of the predefined period, on the user devices, the second data and additional user tools for performing a second predefined action; generate a proposed action based on the plurality of action indications; and execute the proposed action after a completion of the coordination session.

### TECHNICAL FIELD

The present disclosure is related to handling electronic message data and, more particularly, to systems, methods and interactive graphical user interfaces for improved user interaction with and improved processing of electronic order messages in electronic trading networks to thereby expedite processing throughput and minimize storage of un-processable messages.

### BACKGROUND

Systemic problems exist in the field of electronic trading systems. For example, existing electronic trading systems very often have a technical problem of efficiently handling electronic messages to and from participants of various electronic transactions, particularly time-sensitive transactions related to complex multi-component transactions. While conventional electronic trading platforms may enhance trading efficiency of complex multi-component transactions (e.g., allowing users to exchange electronic messages), there are inherent inefficiencies in the electronic transaction process and the configuration of conventional trading platforms that cause technical burdens on these electronic systems.

For example, during a typical electronic auction, some credits may fail to trade for any number of reasons. The storage and processing requirements for retaining the information of those credits can take away computing resources from other tasks and take up bandwidth of communications networks.

Accordingly, there is a need for a new electronic trading system with specially configured hardware and a specific set of rules that can increase efficiency (e.g., via including only orders which have been validated and/or providing an additional session to offload the remaining credits) and reduce latency (e.g., via a specific set of rules to dynamically match orders from a plurality of users) as compared to conventional electronic trading systems.

### SUMMARY

Aspects of the present disclosure relate to methods, systems, and non-transitory computer readable media for electronic transaction processing. The system may include at least one database and at least one server coupled to the at least one database and a plurality of user devices. The at least one database may be configured to store one or more first completed actions and one or more requested actions, to form first data. A predefined period may be initiated by the at least one server. The predefined period may be broadcast to the plurality of user devices during the predefined period. The first data may be displayed via an interactive GUI on the plurality of user devices during the predefined period. User interaction tools for performing one or more first predefined actions associated with the first data may be displayed together with the first data during the predefined period. A plurality of action indications may be received, by the at least one server, from the plurality of user devices via the user interaction tools of the interactive GUI. The plurality of action indications may be associated with the one or more first predefined actions The plurality of action indications may be for a portion of the first data. One or more characteristics associated with the plurality of action indications and the portion of the first data may be determined to meet one or more predetermined conditions. The plurality of action indications that meet the one or more predetermined conditions may be accepted. The accepted action indications may form second data. A coordination session may be initiated by the at least one server at a completion of the predefined period. During the coordination session, the second data and additional user tools may be displayed via the interactive GUI on the plurality of user devices. The additional user tools may be for performing one or more second predefined actions associated with the second data. During the coordination session, one or more proposed actions may be generated based on two or more of the plurality of action indications received from the plurality of user devices via the additional user tools. The one or more proposed actions may be executed by the at least one server after a completion of the coordination session.

### BRIEF DESCRIPTION OF THE DRAWINGS

FIG. 1 is a functional block diagram of an example coordination system, according to an example of the present disclosure.

FIG. 2 is a signal flow diagram illustrating a signal flow of an example coordination session, according to an example of the present disclosure.

FIG. 3 is a diagram illustrating an exemplary graphical user interface (GUI), according to an example of the present disclosure.

FIG. 4 is a diagram illustrating an exemplary GUI, according to an example of the present disclosure.

FIG. 5A is a diagram illustrating an exemplary GUI, according to an example of the present disclosure.

FIG. 5B is a diagram illustrating an exemplary GUI, according to an example of the present disclosure.

FIG. 6 is a flow chart illustrating an example coordination session, according to an example of the present disclosure.

FIG. 7 is a functional block diagram of a coordination system in the example form of a computer system, according to an example of the present disclosure.

### DETAILED DESCRIPTION

The present disclosure is related to handling electronic message data and, more particularly, to systems, methods, and interactive GUIs for improved user interaction with and improved processing of electronic order messages in electronic trading networks to thereby expedite processing throughput and minimize storage of un-processable messages.

Aspects of the present disclosure relate to systems, methods, and computer-readable medium for improved user interaction and electronic order message processing. In some examples, the electronic order message processing may include processing electronic auction orders associated with at least one electronic auction. The electronic auction may include one or more computer algorithms to match buyers and sellers of the same credit and propose a mid-price derived according to a continuous evaluation pricing process for the respective credit. After traders receive proposals, the traders may affirm or reject potential trades on a line-item basis or in bulk. The electronic auction processing may then provide straight-through-processing of affirmed trades. This auction system may provide a robust pool of liquidity in various credit spaces. The auction system may include some functionality that may allow traders to trade based on their own preferences and profiles. For example, traders may be able to define specific constraints such as portfolio level and/or maturity bucket level constraints as well as negative profit and loss (P&L) and size constraints. However, there is a need to provide additional user interaction to provide users with the ability to further modify trades and/or orders post-auction to provide further opportunities for these modified orders/trades to be more effectively processed and ultimately executed.

Aspects of the present disclosure may include at least one server (e.g., including a platform) configured to provide an additional predefined period of time post-auction, referred to as a price improvement volume clearing (PIVC) or coordination period that allows one or more users to place orders on a credit that was part of a primary review phase of an auction session, provided that the specific user meets a set of predetermined conditions. These conditions may include that the specific user: submitted the credit during the upload phase of the corresponding auction session and that at least one of the following criteria are met: (a) the user traded the credit during the auction session; (b) the credit did not trade (“DNT”) during the auction session as a result of no matching affirmations; or (c) the credit “traded away” (e.g., the credit traded during the auction session but the user did not trade the credit). In some examples, the PIVC period (also referred to herein as a PIVC Session), gives users (e.g., traders) the opportunity to further adjust their proposed prices (e.g., more aggressive bids/offers) in order to increase the likelihood that a trade will be generated and ultimately executed (and reducing the likelihood that unfilled orders will need to be held in storage), thereby expediting processing throughput and minimizing storage of un-processable orders. For example, if a particular user is a buyer and the original proposed price (in the auction) of one or more credits was $94.50, the PIVC period may allow that user to interact with the system to move the price to $95.00, thus increasing the likelihood of buying the credits.

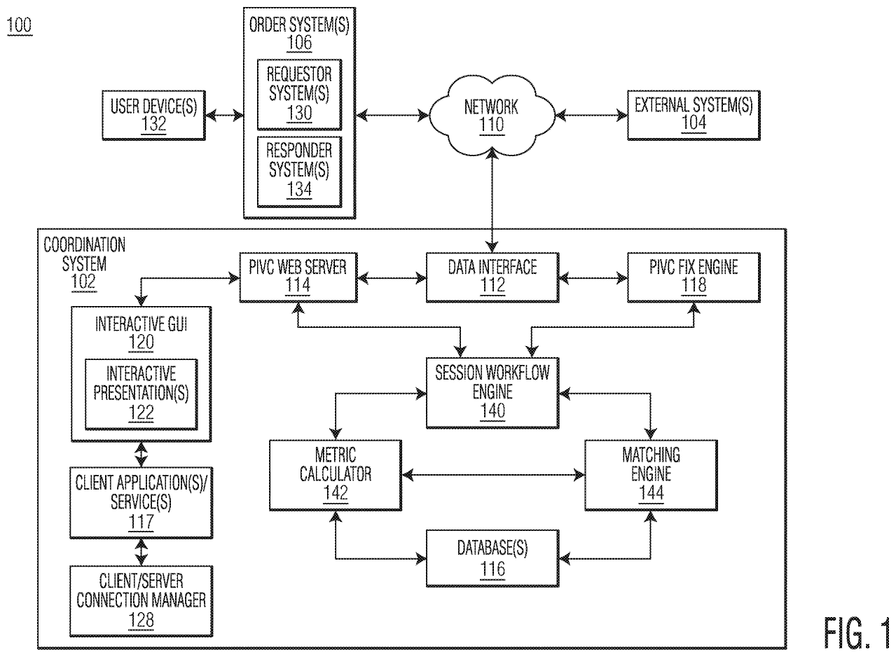

Referring now to FIG. 1, a functional block diagram of an example coordination platform 100 is shown, according to an example of the present disclosure. The coordination platform 100 may include a coordination system 102, one or more order systems 106, one or more user devices 132, and one or more external systems 104. In some examples, one or more components of the coordination platform 100 (e.g., the coordination system 102, the one or more order systems 106, and the one or more external systems 104 may be communicatively coupled via one or more networks 110. The one or more networks 110 may include, for example, a private network (e.g., a local area network (LAN), a wide area network (WAN), intranet, etc.) and/or a public network (e.g., the Internet).

In general, the one or more order systems 106 may include one or more of a server computer, a desktop computer, a laptop, a smartphone, or any other electronic device known in the art configured to receive, capture, and store data (e.g., market data) and/or disseminate any suitable data (e.g., electronic orders, etc.). The one or more order systems 106 may include one or more requestor systems 130 and one or more responder systems 134 configured to exchange various types of electronic messages (e.g., orders) with the coordination system 102 via network 110. In some examples, the one or more requestor systems 130 and/or the one or more responder systems 134 may include one or more of an order management system (OMS) and an execution management system (EMS). The one or more requestor systems 130 and the one or more responder systems 134 may generate and/or store order details (e.g., symbol, side, quantity, available to trade, limit, etc.).

The one or more requestor systems 130 and the one or more responder systems 134 may be in communication with one or more user devices 132. In general, the one or more user devices 132 may include any combination of mobile and/or stationary communication device such as mobile phones, smart phones, tablets, computers, laptop computers, desktop computers, server computers or any other computing device configured to capture, receive, store and/or disseminate any suitable data. The one or more user devices 132 may include a non-transitory memory, one or more processors including machine readable instructions, a communications interface which may be used to communicate with one or more of the one or more requestor systems 130 and the one or more responder systems 134, a user input interface for inputting data and/or information and/or a user display interface for presenting data and/or information. The one or more user devices 132 may also be configured to format and display an interactive GUI 120 generated by the coordination system 102 on the user interface of the one or more user devices 132.

The coordination platform 100 may include one or more external systems 104. In general, the one or more external systems 104 may include one or more of a server computer, a desktop computer, a laptop, a smartphone, or any other electronic device known in the art configured to receive, capture, and store data (e.g., electronic orders, etc.) and/or disseminate any suitable data (e.g., market data). In some examples, the one or more external systems 104 may be any electronic exchange where participants can buy and sell tradable instruments, such as (without being limited to) bonds. The one or more external systems 104 may include one or more of a bond trading platform, a trade capture system, a compliance system, a risk management system, a custodian system, a trade reporting system, a regulatory trade repository, an accounting system, or a clearinghouse. The one or more external systems 104 may receive orders from one or more of the one or more order systems 106 or the coordination system 102. In some examples, the one or more external systems 104 may be a source of real-time market data and/or information (e.g., news information) that may be relevant to market data that may be distributed to one or more of the one or more order systems 106 or the coordination system 102. In some examples, real-time market data may be transmitted by the one or more external systems 104 to one or more third party systems that package and distribute the market data to the one or more order systems 106 and the coordination system 102. Market data that may be distributed by the one or more external systems 104 may include, for example, price data and/or trade-related data associated with one or more tradeable financial instruments.

The coordination system 102 may include a data interface 112, a PIVC web server 114, one or more databases 116, a PIVC Financial Information eXchange (FIX) engine 118, an interactive GUI 120 configured to generate one or more interactive presentations 122, one or more client applications and/or services 117, a client/server connection manager 128, a session workflow engine 140, a metric calculator 142, and a matching engine 144. In some examples, the one or more components of the coordination system 102 may communicate with each other via a data and control bus. Although the coordination system 102 is shown as one component (e.g., a server), the coordination system 102 may include one or more components (e.g., one or more servers) that are co-located and/or linked across one or more networks.

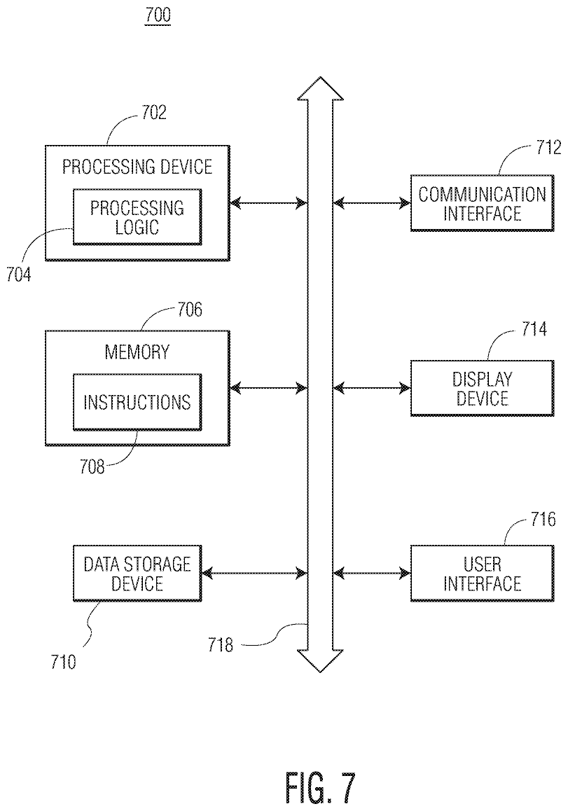

The coordination system 102 may include at least one processor (e.g., processing device 702 shown in FIG. 7) and non-transitory memory (e.g., memory 706 shown in FIG. 7) storing one or more routines and or algorithms for performing the functions of the coordination system 102 described herein. An example implementation of one or more components of the coordination system 102 is shown by computer system 700 (shown in FIG. 7). In general, the coordination system 102 may include one or more of a server computer, a desktop computer, a laptop, a smartphone, or any other electronic device known in the art configured to receive, capture, and store data (e.g., market data and/or electronic messages) and/or disseminate any suitable data (e.g., electronic messages and/or electronic orders, etc.).

The coordination system 102 may communicate with the order systems 106 (e.g., the one or more requestor systems 130 and the one or more responder systems 134), as well as (in some examples) the one or more external systems 104 via the data interface 112. The data interface 112 may include one or more input and/or output interfaces (e.g., an electronic device including hardware circuitry, an application on an electronic device) for communication with the one or more requestor systems 130 and the one or more responder systems 134 and other components of the coordination platform 100. The data interface 112 may include security protection (e.g., encryption, decryption) to protect the integrity of the communications. In an example, the data interface 112 may communicate with the one or more requestor systems 130 and the one or more responder systems 134 (as well as the one or more order systems 106 generally) via a FIX protocol, which is a secure open electronic communications protocol designed to standardize and streamline electronic communications in the financial services industry. The FIX protocol may support multiple formats and types of communications between financial entities including trade allocation, order submissions, order changes, and execution reporting.

The data interface 112 may be configured to perform one or more of filtering, data normalization, data reformatting, data aggregation, or the like. In some examples, electronic data that may be obtained by the data interface 112 may include data that may be unable to be processed (e.g., data that includes one or more errors or the like). In some examples, the one or more order systems 106 (e.g., the one or more requestor systems 130 and/or the one or more responder systems 134) may transmit data with various unique, non-standard values and/or data formats (e.g., proprietary formats). Furthermore, data content may correspond to different forms of data, such as different currencies, date formats, time periods, etc.

Non-limiting examples of data filtering that may be performed by the data interface 112 may include excluding null data values, excluding corrupted data, excluding outlier data values (e.g., a data value outside of a pre-defined value range, outside of a pre-defined time range) and the like.

In some examples, the data interface 112 may be configured to reformat the collected data to one or more common formats and/or normalize the collected data. In some examples, the data interface 112 may be configured to aggregate and/or combine at least a portion of the collected data (e.g., according to one or more pre-defined categories (such as a type of data, one or more predetermined time periods, etc.). The data interface 112 may normalize data to ensure that formatting/naming/categorization of the data is consistent. This may allow the data to be processed by the coordination system 102 and displayed by the interactive GUI 120 in a consistent, normalized manner, regardless of the original data source.

The PIVC web server 114 may be configured to communicate with various components of the coordination system 102, including the data interface 112, the session workflow engine 140, and the interactive GUI 120. Although not shown in FIG. 1, the PIVC web server 114 may also be configured to communicate with the PIVC FIX engine 118, the metric calculator 142, the matching engine 144, the one or more databases 116, the one or more client applications and/or services 117, and/or the client/server connection manager 128. The PIVC web server 114 may be configured to retrieve data from the one or more databases 116 and perform one or more operations, including the PIVC process described herein, including the generation of PIVC orders that may ultimately be sent to session workflow engine 140 and/or matching engine 144 for processing and execution. In general, the one or more databases 116 may be configured to store one or more of requestor and/or responder rating information, PIVC requests, PIVC responses, PIVC orders, or order execution details. In some examples, the PIVC web server 114 may include a tick engine and may be coupled to the one or more databases 116 to enable processing of large amounts of data that may change rapidly (e.g., user orders, market events, quotes, transaction data, etc.).

PIVC FIX engine 118 may be configured to standardize and/or streamline electronic communications between one or more of order systems 106, one or more external systems 104, or coordination system 102. PIVC FIX engine 118 may be configured to support multiple formats and types of communications including one or more of trade allocation, order submissions, order changes, or execution reporting.

The interactive GUI 120 may be configured to communicate with PIVC web server 114 and the one or more client applications and/or services 117. The interactive GUI 120 may be configured to generate one or more interactive presentations 122 for display on the one or more user devices 132 (e.g., that may be in communication with the one or more order systems 106). In an example, the one or more interactive presentations 122 may allow a requestor (e.g., associated with one of the requestor system(s) 130) to input information about a plurality of bonds, such as, for example, bond identifier (ID), size and direction (e.g., buy or sell), to create a group of bond orders. The one or more interactive presentations 122 may allow a selected recipient (e.g., associated with one of the responder system(s) 134) to view the group of bond orders, select individual bonds for a trade, and input a best price for the requestor to consider.

In some examples, the interactive GUI 120 may update the one or more interactive presentations 122 in real time. In some examples, the interactive GUI 120 may update the one or more interactive presentations 122 at predetermined intervals. The one or more interactive presentations 122 may be transmitted to the one or more requestor systems 130 and selected ones of the one or more responder systems 134 and then displayed on the one or more user devices 132. The interactive GUI 120 may relay the user input received from among the user devices 132 to the PIVC web server 114. In some examples, the one or more interactive presentations 122 may include different configurations for the requestor and the selected responders. In some examples, the one or more interactive presentations 122 may include different configurations depending on characteristics of the various responders that are selected, via the PIVC web server 114, to potentially participate in the PIVC process.

In some examples, the one or more interactive presentations 122 may include different configurations based on an underlying application and/or service for which it is launched. For example, the interactive GUI 120 may have a first configuration for a mobile application, may have a second (different) configuration for a desktop application, and may have a third (different) configuration for a spreadsheet application. In some examples, the one or more interactive presentations 122 may have different configurations.

The coordination system 102 may include one or more client applications and/or services 117 for creating one or more instances of application(s) and/or service(s) based on attributes of one or more of the one or more order systems 106 or the one or more user devices 132 (e.g., device type, screen size, etc.). For example, the one or more client applications and/or services 117 may create instances of one or more of a trading desktop, a spreadsheet application, a mobile application (e.g., an application that may be suitable for a display screen of a mobile device such as a tablet and/or smartphone), streaming (e.g. raw, normalized, filtered and/or aggregated) data feeds or one or more APIs for receiving data in one or more object-oriented programming languages (e.g., Java, Python™, R, etc.).

The coordination system 102 may include a client/server connection manager 128 (also referred to as connection manager 128) configured to manage client to server connection requests. In general, connection manager 128 may manage connection request(s) of the requester system(s) 130 and the one or more responder systems 134 to the coordination system 102 (as well as the one or more order systems 106 generally) and coordinate with the one or more client applications and/or services 117.

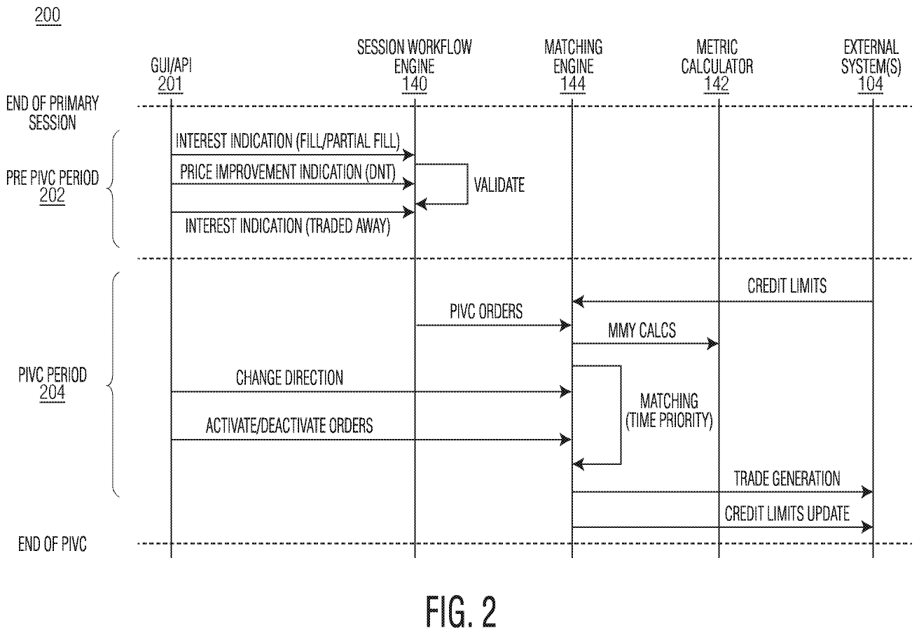

The session workflow engine 140 may be configured to guide a PIVC process (that may be implemented as part of one or more coordination sessions). The PIVC process may include a pre-PIVC period (described in FIG. 2) and a PIVC period (described in FIG. 2). Session workflow engine 140 may be configured to launch one or more coordination sessions across one or more sectors including, without being limited to, one or more of sectors in high yield, investment grade, or emerging markets. In some examples, a coordination session may include eligible credits that were part of an auction session (e.g., those credits that were part of a primary review phase) immediately preceding the coordination session. Session workflow engine 140 may be configured to select a group of subscribers to participate in the coordination session. In some examples, the subscribers may be specifically permissioned to participate. Session workflow engine 140 may retrieve the subscriber information from one or more of database(s) 116, external system 104 through data interface 112, or the like. In some examples, one or more credits may be spotted at a specific price at the end of a coordination session and/or may be aggregated at the user level (e.g., rather than at a subscriber level).

Session workflow engine 140 may be configured to set a launch time for the coordination session. The launch time may be broadcast to one or more interactive GUIs 120 through PIVC web server 114 to be displayed on one or more user devices 132. Session workflow engine 140 may be configured to set a duration of the coordination session (e.g., 10 minutes). The duration may be selected to be any length of time. The duration of the coordination session sets the amount of time in which trades are able to be matched to users and/or subscribers based on interest and price entered in a pre-PIVC period.

Session workflow engine 140 may be configured to receive and validate one or more indications from the interactive GUI 120 during the pre-PIVC period. In some examples, indications which session workflow engine 140 cannot validate may be discarded. The one or more indications may include, for example, interest indications and/or price improvement indications for one or more of units in filled/partially filled trades, units that did not trade, or units that traded away. Session workflow engine 140 may be configured to determine whether a user meets one or more predefined conditions before validating the one or more indications. In some examples, session workflow engine 140 may only permit interest indications during the pre-PIVC period and not during the coordination session. When the coordination session begins, session workflow engine 140 may be configured to transform the interest indications entered during the pre-PIVC period into orders.

In some examples, session workflow engine 140 may be configured to permit a change in the direction of an order submitted by a user. For example, if the user during the auction session placed a buy order, session workflow engine 140 may permit the user to change the order to a sell order, thus changing the direction of the order.

The metric calculator 142 may be configured to calculate a fair value of one or more credits based on one or more metrics. For example, metric calculator 142 may be configured to calculate the value based on one or more of a credit's face value, coupon rate, yield, maturity date, or one or more money market yield (MMY) calculations.

The matching engine 144 may be configured to match buy and sell orders between users in order to execute trades. For example, if User A has indicated an interest in buying 100 units at a price of $95.00/unit and User B has indicated an interest in selling 100 units at a price of $95.00/unit, matching engine 144 may match the orders of User A and User B to execute the trade of 100 units at the price of $95.00/unit, assuming one or more predefined conditions are met. In some examples, matching engine 144 may be configured to partially fill an order in order to match buy and sell orders. For example, if User B of the previous example only has 50 units and User C has 60 units and has indicated an interest in selling the 60 units at $95.00, then matching engine 144 may be configured to match User A with both User B and User C. Assuming User B has a higher priority than User C, matching engine 144 may match User B's 50 units to User A's order and 50 of User C's 60 units to User A's order.

Matching engine 144 may be configured to implement one or more processes to determine which order should receive priority in matching. In some examples, priority may be determined based on one or more of time of submission, quantity of order, user, or trade price. For example, a submitted interest indication with a time stamp earlier than a second submitted interest indication may be granted higher priority than the second submitted interest indication. In some examples, if two orders are matched on one or more of the options for priority, matching engine 144 may determine priority on an option they do not match on. For example, if User A submitted an interest indication for Credit 1 at the same time stamp as User B and included the same price, the matching engine 144 may use the quantity of the orders to determine priority. In some examples, matching engine 144 may not allow parties who represent the same entity to match on an order.

In some examples, matching engine 144 may be configured to propose trades based on a derived mid-price. The derived mid-price may be based on one or more of target buy price, target sell price, historical credit price, a continuously evaluated pricing, a comparison between live orders and the continuously evaluated pricing, or the like.

Accordingly, the systems and methods disclosed herein provide a new electronic trading system with specially configured hardware and a specific set of rules that can increase efficiency (e.g., via including only orders which have been validated and/or providing an additional session to offload the remaining credits) and reduce latency (e.g., via a specific set of rules to dynamically match orders from a plurality of users) as compared to conventional electronic trading systems. For example, interactive GUI 120 may provide information to one or more user devices 132 to increase the engagement of potential traders using one or more interaction tools (e.g., countdown timer, cell entry options including dragging and/or pasting information, and/or real-time updates of detailed information regarding credits and/or trades) which aid in expediting processing throughput and minimizing storage of un-processable messages (e.g., unfilled orders) on the computer system.

Referring now to FIG. 2, a sequence diagram of a coordination workflow 200 is shown, according to an example of the present disclosure. As illustrated in FIG. 2, electronic communications are exchanged between a GUI/API 201, a session workflow engine 140, a matching engine 144, a metric calculator 142, and an external system 104 across multiple phases. In some examples, GUI/API 201 may represent interactive GUI 120 (FIG. 1) and/or an API generated by client application(s)/service(s) 117 (FIG. 1). During a pre-PIVC period 202 that follows the end of a primary session, interest indications may be communicated from the GUI/API 201 to the session workflow engine 140 for validation. The interest indications may include, for example, one or more of fill or partial fill notifications, price improvement indications, or interest indications for items that were traded away.

Session workflow engine 140 may be configured to validate the indications. In some examples, the validation may include (without being limited to) one or more of comparison to a minimum activation quantity, comparison to a maximum activation quantity, the direction of an order, determination of a complete order, determination of the user's status during the auction session, or the like. For example, the determination of the user's status may include (without being limited to) determining one or more of the user having traded a quantity of the credit in the auction session, the user had a proposal on the credit, the user received a proposal on the credit, or the like. The maximum activation quantity may assist in preventing bad trades, which may occur if a user made an error in the size of the order.

A PIVC period 204 may follow the pre-PIVC period 202, during which limit data may be obtained by matching engine 144 from the external system 104. Limit data may include a maximum number of units that are available to be traded. One or more PIVC orders may be transmitted from the session workflow engine 140 to the matching engine 144. One or more calculations (e.g., MMY calculations) may be performed by the metric calculator 142 based on the one or more PIVC orders. During the PIVC period 204, users may provide one or more indications to change direction and/or activate or deactivate orders via the GUI/API 201. For example, if a user bought one or more units during the primary session, the user may change direction during the PIVC period 204 and sell one or more units. In some examples, the changing of direction may include changing a proposed trade to decrease the quantity of units to buy and including a quantity of units to sell. The session workflow engine 140 may be configured to receive these user inputs and may coordinate with the matching engine 144, such that matching engine 144 may perform matching based on time priority. At the conclusion of the PIVC period 204, the coordination system 102 may transmit one or more of trade generation signals or limit updates to one or more external systems 104.

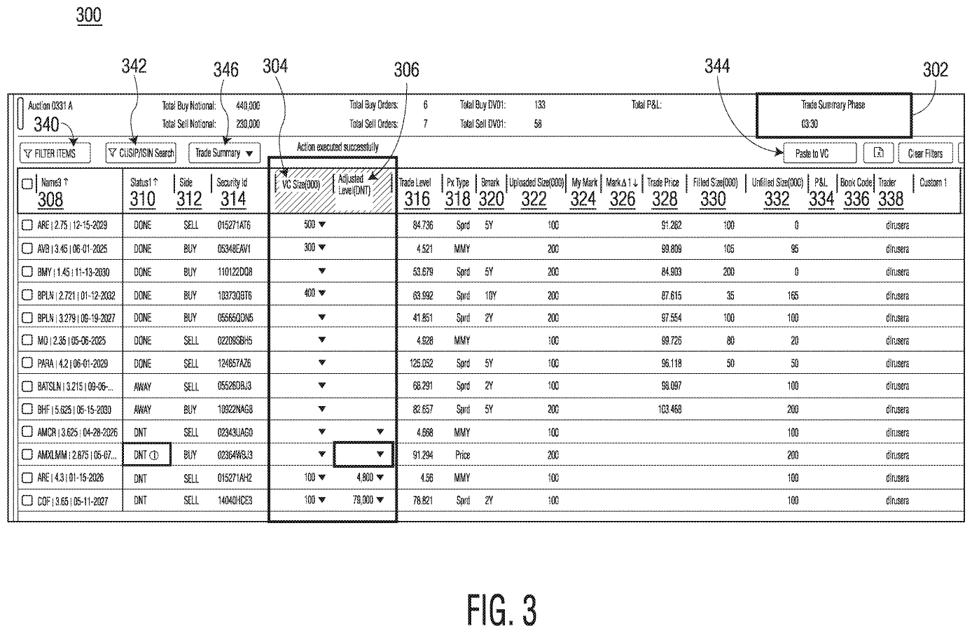

Referring now to FIG. 3, an exemplary GUI 300 of a trade summary screen is shown, according to an example of the present disclosure. The GUI 300 may be an example of one or more interactive presentations 122 that may be generated by interactive GUI 120. The one or more interactive presentations 122 may be generated at least in part using information from session workflow engine 140. The GUI 300 may display metric data in a tabular format during a trade summary phase that precedes a PIVC period (e.g., a pre-PIVC period). During the trade summary phase, users may be provided with a configurable amount of time (e.g., timer 302) to review all affirmed bonds that did not trade (DNT) and traded ones (done, away) after trades are generated. Users can suggest price improvement for DNT orders and also activate done and away trades by pasting a size in the trade summary screen (e.g., as shown at VC size 304 and adjusted level 306).

During the PIVC period, a volume clearing (VC) tab of the trade summary screen may include bonds that traded or have suggested improvement and were in the user's proposal list. In some examples, PIVC orders may be permitted to be viewed by the particular user entering the order during the PIVC period or by another user at the same subscriber, but may be prevented from being disclosed to other subscribers.

The GUI 300 may include columns for one or more of metric name 308, status 310, side 312, security ID 314, VC size 304, adjusted level 306, trade level 316, price type (“Px Type”) 318, benchmark (“Bmark”) 320, uploaded size 322, mark (“My Mark”) 324, mark delta (“Mark Δ1”) 326, trade price 328, filled size 330, unfilled size 332, P&L 334, book code 336, trader 338, or additional fields. A trade summary phase countdown timer 302 may be displayed on the interface (e.g., prior to the PIVC period). At the end of the timer 302, GUI 300 may auto-switch the user to a volume clearing screen and the PIVC period may commence.

In some examples, the metric name 308 may include one or more of ticker, coupon, or maturity of a credit information. The status 310 may include an indication of a status of a trade, such as done (e.g., indicating a completed trade), away (e.g., indicating the credit was purchased by another user), or DNT (e.g., indicating the credit did not trade). The side 312 may include an indication of whether the user was attempting to buy or sell the listed credit. The VC size 304 and adjusted level 306 columns may correspond to the size entered by a user during the pre-PIVC period and the price improvement indication for the size, respectively. The trade level 316 may include an indication of price at which the credit traded during the auction session. The price type 318 may indicate the price type that the credit traded during the auction session (e.g., spread, price, or money market yield). The benchmark 320 may indicate a benchmark for the credit. Mark 324 may indicate a target level and/or price of the user. Mark delta 326 may indicate a difference between the target level (mark 324) and the actually traded level 316 for the credit. GUI 300 may also include one or more controls for filtering (e.g., filter items selector 340), searching (e.g., CUSIP/ISIN search selector 342), and pasting (e.g., a Paste to VC function 344) for submitting orders to the session. In some examples, GUI 300 may include a configurable tab 346 which may be used to view different implementations of GUI 300 (e.g., Trade Summary).

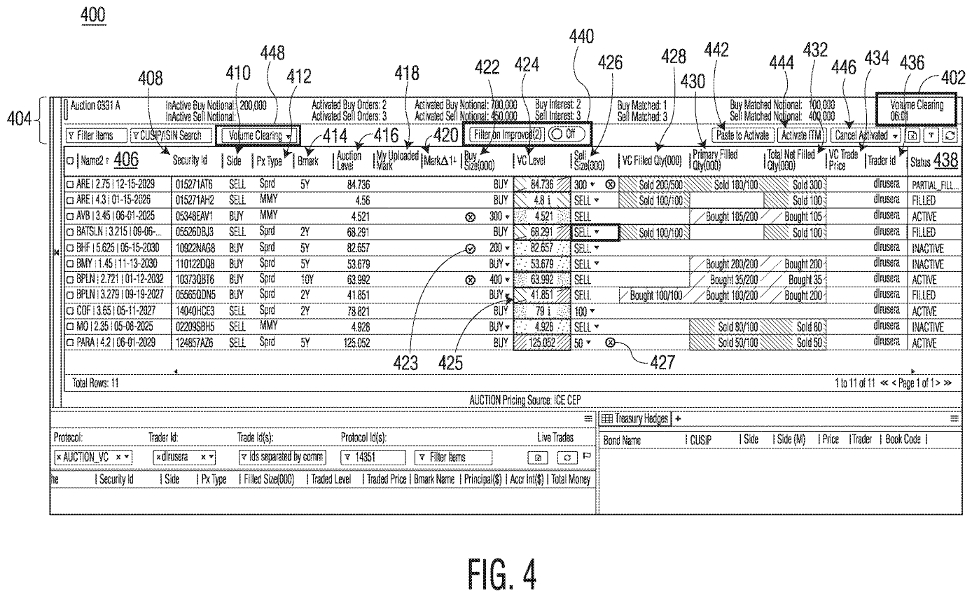

Referring now to FIG. 4, an exemplary GUI 400 of a volume clearing tab 448 is shown, according to an example of the present disclosure. The GUI 400 may be an example of one or more interactive presentations 122 that may be generated by interactive GUI 120. The one or more interactive presentations 122 may be generated at least in part using information from session workflow engine 140. The GUI 400 may display credit order data during a PIVC session. A header area 404 may include information showing one or more of inactive and activated buy/sell notional values, activated order counts, buy/sell interest counts, or matched notional values. A volume clearing countdown timer 402 may be displayed on the GUI 400. The GUI 400 may include a data grid having columns for one or more of credit name 406, security ID 408, side 410, price type (“Px Type”) 412, benchmark (“Bmark”) 414, auction level 416, uploaded mark 418, mark delta (“Mark Δ1”) 420, buy size 422, VC level 424, sell size 426, VC filled quantity 428, primary filled quantity 430, total net filled quantity 432, VC trade price 434, trader ID 436, or status 438. VC level 424 may indicate the trade level on the credit from the auction session and/or the suggested level accepted by the coordination system 102 for DNT orders. In some examples, GUI 400 may include a color and/or shading of the cells of VC level 424 to indicate one or more of an inactive order with no interest remaining from any user, only one order for the credit without a contra order, interest on both sides, fully matched without any remaining interest, or partially matched with remaining interest. A split cell 425 may be used to indicate a partial match in orders with interest remaining in the credit. VC filled quantity 428 may indicate matched quantity out of the total quantity that the user uploaded. Primary filled quantity 430 may indicate the original traded quantity from the auction session out of the total uploaded quantity. Buy size 422 and sell size 426 may indicate a remaining quantity after the user's original order was partially filled. The user may edit one or more of these cells and may change direction (e.g., from sell to buy). In some examples, GUI 400 may include one or more icons 423 (for example, green check marks) adjacent a quantity. The icon 423 may indicate the order is not yet activated. In some examples, the user may select the icon 423 to activate the order. In some examples, GUI 400 may include one or more icons 427 (for example, red “x” mark) adjacent orders which are only partially filled. The icon 427 may indicate an ability to cancel the order that has remaining size. Total net filled 432 may indicate the net quantity of matched units during both the auction session and the coordination session. VC trade price 434 may indicate the trade price at the end of the coordination session. In some examples, GUI 400 may include a control option 440 to filter credits that have an improved level based on indications from the pre-PIVC period and did not trade during the auction session. Status 438 may indicate whether orders on the credit are inactive, active, partially filled, or filled. Control for filtering on improved orders (e.g., control option 440), pasting to activate 442, activating in-the-money orders 444, and canceling 446 activated orders may be provided in the GUI 400. In some examples, GUI 400 may include a configurable tab 448 which may be used to view different implementations of GUI 400 (e.g., Volume Clearing).

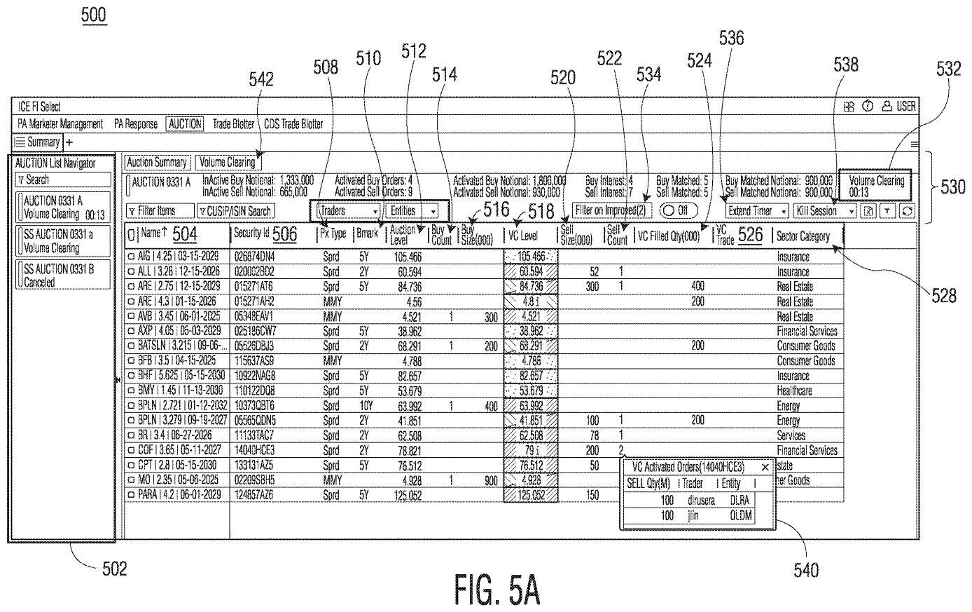

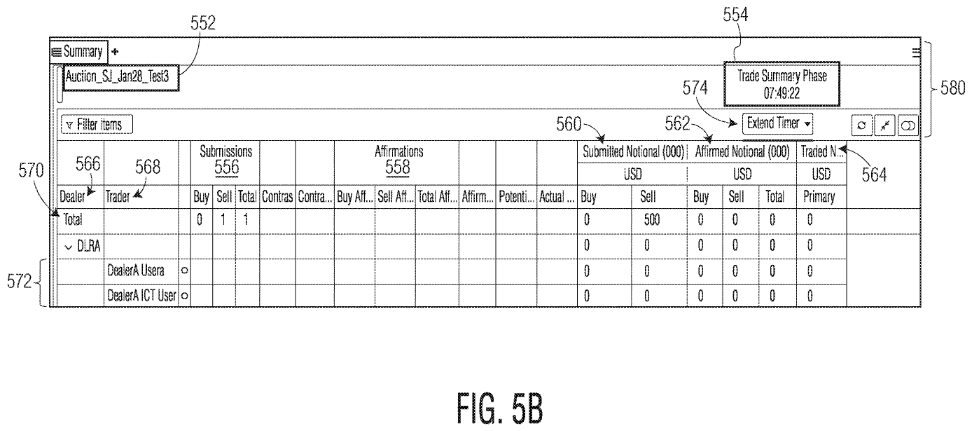

Referring now to FIG. 5A, an exemplary GUI 500 of a volume clearing tab 542 in an alternative view is shown, according to an example of the present disclosure. The GUI 500 may be an example of one or more interactive presentations 122 that may be generated by interactive GUI 120. The one or more interactive presentations 122 may be generated at least in part using information from session workflow engine 140. The GUI 500 may be an exemplary view of a marketer screen during a PIVC period. Accordingly, GUI 500 may include orders from all users for these credits. The GUI 500 may include an auction list navigator panel 502 positioned along a portion of the display showing multiple sessions. A main data area may display credit trading information during a coordination session with columns for one or more of credit name 504, security ID 506, price type (“Px Type”) 508, benchmark (“Bmark”) 510, auction level 512, buy count 514, buy size 516, VC level 518, sell size 520, sell count 522, VC filled quantity 524, VC trade price 526, or sector category 528. A header area 530 may display session information including inactive and activated buy/sell notional values and interest counts. A volume clearing countdown timer 532 may be shown in in the header area 530 of the GUI 500. Filter controls for traders and entities may be provided on the GUI 500. GUI 500 may include control options for one or more of filtering on improved orders 534, extending the timer 536, and killing the session 538. The GUI 500 may include a popup dialog 540 configured to display VC activated order details for a selected credit, including sell quantity, trader, and entity information. In some examples, GUI 500 may include a configurable tab 542 which may be used to view different implementations of GUI 500 (e.g., Volume Clearing).

Referring now to FIG. 5B, an exemplary GUI 550 of a marketer screen for a trade summary phase is shown, according to an example of the present disclosure. The GUI 550 may display a summary view with a session identifier 552 shown on the display. A trade summary phase indicator with a countdown timer 554 may be displayed on GUI 550. The GUI 550 may include a data grid having columns organized into groupings for one or more of submissions 556, affirmations 558, submitted notional values 560, affirmed notional values 562, or traded notional values 564. The submissions 556 grouping may include sub-columns for one or more of buy, sell, and total for each dealer 566 and trader 568.. The affirmations grouping may include sub-columns for one or more of buy affirmations, sell affirmations, total affirmations, affirm percentage, potential affirmations, or actual affirmations. The submitted notional 560 and affirmed notional 562 groupings may display values for buy and sell amounts. The data grid may display a total row 570 and expandable dealer-level rows 572 with individual trader entries, enabling a marketer to view aggregated and detailed trading activity across participants. An extend timer control 574 may be provided in a header area 580 of the GUI 550 to allow extension of the trade summary phase duration.

It should be understood that the example GUIs 300, 400, 500, and 550 in respective FIGS. 3-5B represent non-limiting example user interfaces, and that differing interface configurations in accordance with this disclosure may be provided for presentation and user interaction with the various data in the pre-PIVC period 202 and the PIVC period 204.

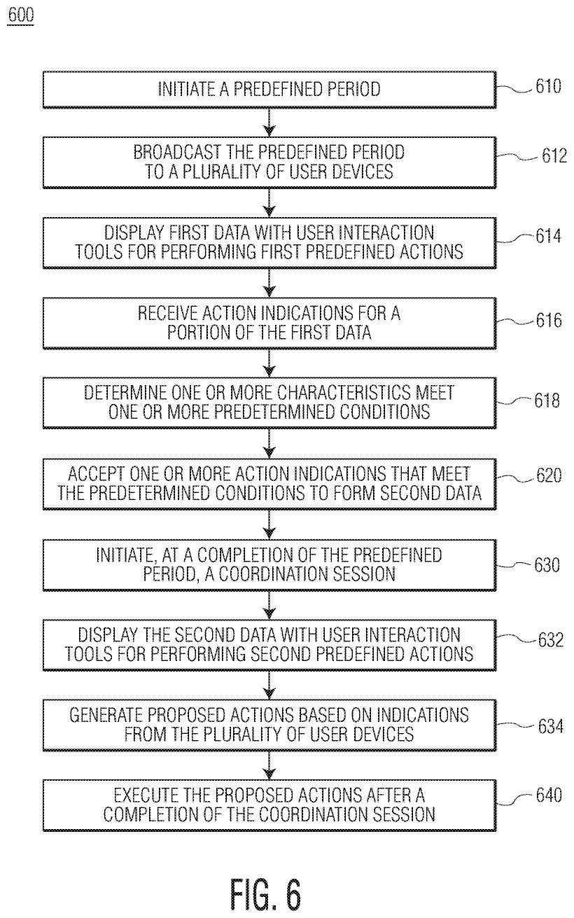

Referring now to FIG. 6, a flow chart of an example coordination session process 600 is shown, according to an example of the present disclosure.

At step 610, coordination system 102 may initiate a predefined period at a conclusion of an electronic auction. The predefined period may be referred to as a pre-coordination period. In some examples, the predefined period may be referred to a pre-PIVC activation period or pre-PIVC period 202, during which users may have the opportunity to review auction data from the electronic auction. The auction data may include one or more of credits a user obtained, credits the user affirmed during a primary review phase that did not trade, or credits the user affirmed during the primary review phase that another user obtained. In some examples, the predefined period may have a configurable duration, for example, a default of ten minutes, to allow users to review candidates to trade on and submit to a volume clearing phase (e.g., a PIVC period 204).

At step 612, coordination system 102 may broadcast the predefined period to the plurality of user devices 132. In some examples, the coordination system 102 may transmit a notification to each user device indicating the commencement of the predefined period (e.g., a pre-PIVC period 202) along with a countdown timer displaying the remaining duration. For example, the timer may be displayed as timer 302 on GUI 300. The broadcast may include information enabling users to access an interactive GUI (e.g., GUI 300 shown in FIG. 3) configured to display the auction data together with user interaction tools. In some examples, the broadcast may be transmitted via a network (e.g., network 110) to user devices associated with users who participated in the electronic auction and meet a set of predetermined conditions for participation in the subsequent volume clearing phase (e.g., the PIVC period 204). The predetermined conditions may include that the user submitted a credit during an upload phase of the corresponding auction session and that at least one of the following criteria are met: the user traded the credit during the auction session, the credit did not trade during the auction session as a result of no matching affirmations, or the credit traded during the auction session but the user did not obtain the trade. In some examples, the coordination system 102 may automatically switch the user interface on each user device to a volume clearing screen (e.g., GUI 400 shown in FIG. 4) at the conclusion of the predefined period when the countdown timer expires.

At step 614, coordination system 102 may display, via the interactive GUI, the auction data (e.g., first data) together with user interaction tools for performing one or more predefined actions associated with the auction data (e.g., GUI 300 shown in FIG. 3). In some examples, the interactive GUI may present the auction data in a tabular format including columns for one or more of metric name, status, side, security identifier, trade level, price type, benchmark, uploaded size, mark, trade price, filled size, unfilled size, profit and loss, book code, or trader information. In some examples, the user interaction tools may include (without being limited to) a VC size column and an adjusted level column that may enable users to enter sizes and proposed price improvements for eligible credits. For credits that did not trade during the auction session, users may enter a price improvement indication in the same direction as their original order, where the price improvement may represent a more aggressive bid or offer value to increase the likelihood of trade execution. The coordination system 102 through session workflow engine 140 may validate the entered size against the user's trading limit and/or a minimum quantity constraint, and may validate the adjusted level against the direction of the trader's order to confirm that the adjustment is within an allowed threshold. The allowed threshold may be configurable, for example, a price threshold within a predefined number of cents or a spread threshold within a predefined percentage. The interactive GUI may include one or more of controls for filtering, a security identifier search option, or a paste function that may allow users to paste size and proposed level data from an external source. For credits that traded during the auction session, users may enter their interest indication at the same price to trade additional size, and for credits that traded away, users may enter their interest at the price the credit traded during the auction session.

At step 616, the coordination system 102 may receive, from the plurality of user devices 132 via PIVC FIX engine 118 and/or PIVC web server 114, one or more action indications associated with the one or more predefined actions for a portion of the auction data (e.g., first data) via the user interaction tools of the interactive GUI. The action indications may include size entries and/or proposed level adjustments submitted by users (e.g., through the VC size column and adjusted level column of GUI 300). In some examples, users may submit action indications by clicking a Paste to VC button on GUI 300 and/or by pasting data from a spreadsheet having columns for one or more of security identifier, VC size, or adjusted level. The coordination system 102 may receive action indications for credits having different statuses, including credits that traded during the auction session, credits that did not trade, and/or credits that traded away. For credits that traded during the auction session, the action indication may include a size in the same direction as the original trade to indicate interest in trading additional quantity at the same price. For credits that did not trade during the auction session, the action indication may include both a size and a proposed price improvement in the same direction as the user's original order, where the price improvement may represent a more aggressive bid or offer value. For credits that traded away during the auction session, the action indication may include a size at the price the credit traded during the auction session. In some examples, users may also enter action indications by clicking directly in cells on individual rows of the interactive GUI and entering size and/or level values. The coordination system 102 may assign a timestamp to each received action indication for purposes of determining priority during the subsequent volume clearing phase.

At step 618, the coordination system 102 may determine that one or more characteristics associated with the one or more action indications and the portion of the auction data (e.g., first data) meet one or more predetermined conditions. The coordination system 102 may validate the received action indications against multiple criteria to determine eligibility for the volume clearing phase (e.g., the PIVC period 204). For action indications associated with credits that traded during the auction session or traded away, the coordination system 102 may validate that the included size is less than or equal to a maximum activation quantity and greater than or equal to a minimum trade quantity constraint, and may ignore any price value if the user included one. For action indications associated with credits that did not trade during the auction session, the coordination system 102 may validate that the included size is less than or equal to the maximum activation quantity and greater than or equal to the greater of the minimum trade quantity and a minimum activation quantity. The coordination system 102 may further validate the suggested level based on price type and side. For price-type orders, the coordination system 102 may accept the suggested level if the side is buy and the improved level minus the original level is less than or equal to a price threshold and greater than zero, or if the side is sell and the original level minus the improved level is less than or equal to the price threshold and greater than zero. For spread-type orders, the coordination system 102 may accept the suggested level if the side is sell and the improved level minus the original level is less than or equal to a spread threshold and greater than zero, or if the side is buy and the original level minus the improved level is less than or equal to the spread threshold and greater than zero. For example, the price threshold may be configured as a predefined number of cents and the spread threshold may be configured as a predefined percentage. If multiple users have submitted price improvements for the same credit, the coordination system 102 may select the best improved level based on the direction and price type, discarding other adjustments. Action indications that do not satisfy the validation criteria may be rejected and not displayed in the interface.

At step 620, the coordination system 102 (e.g., via session workflow engine 140) may accept those among the one or more action indications that meet the one or more predetermined conditions, to form eligible order data (e.g., second data). The eligible order data may include validated size entries and proposed level adjustments that have passed the system validation criteria during the predefined period. For action indications associated with credits that traded during the auction session or traded away, the coordination system 102 may accept the size value and associate it with the original trade price from the auction session. For action indications associated with credits that did not trade during the auction session, the coordination system 102 may accept both the size value and the best improved level submitted by users. In some examples, if multiple users have submitted price improvements for the same credit, the coordination system 102, via session workflow engine 140, may determine the best improved level based on the direction and price type. For price-type orders on the buy side, the coordination system 102 may select the highest improved level, and for price-type orders on the sell side, the coordination system 102 may select the lowest improved level. For spread-type orders on the buy side, the coordination system 102 may select the lowest spread, and for spread-type orders on the sell side, the coordination system 102 may select the highest spread. The coordination system 102 may discard other adjustments that are not selected as the best improved level. In some examples, where both sides affirmed and did not win a trade and have entered price improvements within limits, the coordination system 102 may take the midpoint of the best improved level on each side and display the mid-price when the volume clearing phase (e.g., the PIVC period 204) starts with immediate match. The accepted action indications may be assigned timestamps for purposes of determining priority during the subsequent volume clearing phase (e.g., PIVC period 204), where priority may be based on time of activation. The eligible order data may be stored in one or more databases (e.g., database(s) 116) and prepared for transfer to the volume clearing phase at the conclusion of the predefined period (e.g., the pre-PIVC period 202).

At step 630, the coordination system 102 may initiate, at a completion of the predefined period (e.g., the pre-PIVC period 202), a coordination session that may include a PIVC process (e.g., as shown in FIG. 2). In some examples, the coordination session may be launched at the conclusion of the pre-PIVC activation period, and eligible interest entered by users during the pre-PIVC activation period may be transferred to the coordination session and may become orders. The coordination session may include eligible credits that were part of a primary review phase of an auction session immediately preceding the coordination session. In some examples, the coordination session may include a select group of subscribers who have specific permission to participate. The coordination system 102 (e.g., via matching engine 144) may obtain credit limits from an external system 104 and/or database(s) 116 at the onset of the coordination session to establish trading constraints for participants. The coordination session may have a configurable duration, for example, a default of ten minutes, during which users may enter orders for each credit for which they met the set of predefined conditions. In some examples, for credits that did not trade during the auction session but for which there was at least one improved price, users may be permitted to change the direction of the order if the user did not enter a price improvement indication during the pre-PIVC activation period. If the user entered a price improvement during the pre-PIVC activation period, the user may not be permitted to direct a change in the order. For example, a change may include a change in price and/or size. For credits that traded during the auction session, the price at which such credit traded may remain the same in the coordination session, and users who were either a party to such trades or who were not able to trade the credit during the auction session may be permitted to enter a size for the order in either direction. In some examples, where a user matches on an order in the coordination session, the user may not be permitted to change direction. The coordination system 102 may display a countdown timer indicating the remaining duration of the coordination session. For example, the timer may be displayed as timer 402 on GUI 400.

At step 632, the coordination system 102 may display, via the interactive GUI, the eligible order data and additional user tools for performing one or more predefined actions associated with the eligible order data. For example, session workflow engine 140 may perform the transition between the display of the predefined period (e.g., the pre-PIVC period 202) and the coordination session (e.g., PIVC period 204) and may signal the interactive GUI 120 through PIVC web server 114 to update the GUI on one or more user devices 132 to transition from one screen (e.g., GUI 300) to another screen (e.g., GUI 400). In some examples, the interactive GUI may present the eligible order data in a tabular format with rows grouped by price type, including one or more of spread-based orders or price and money market yield orders. The interface may include columns for one or more of credit name, security identifier, price type, benchmark, primary level, primary side, uploaded mark, mark delta, primary filled quantity, buy size, sell size, volume clearing level, volume clearing filled quantity, total filled quantity, trade price, or trader identifier. The additional user tools may include one or more of an export function that allows users to export all rows including suggested sizes, a paste to activate function that allows users to paste security identifiers and quantities to activate orders, an activate in-the-money function that activates all orders with carried-over size and positive mark delta with a single click, or a cancel all function that cancels active orders for the user. In some examples, for active orders, the volume clearing level column may display color-coded indicators to show order status, including, for example, blue with grey font for inactive orders with no interest, purple with bold size for orders where only the activating trader has interest, orange to indicate at least one side has interest, red to indicate full size is matched, or half orange and half red to indicate partial size matched with additional interest remaining. The coordination system 102 may update the buy and sell size columns with remaining quantity as orders are matched, and the volume clearing filled quantity column may display the matched quantity as soon as active sizes in opposite directions are matched. Users may be permitted to upsize or downsize orders in the same direction. In some examples, matched quantity may not be cancelled until trades are generated at the conclusion of the coordination session. In some examples, for improved orders, the trader who submitted the price improvement may be locked for the direction and minimum activation size during the coordination session, such that the improving trader may upsize but may not downsize below the minimum activation size and may not change direction.

At step 634, the coordination system 102 (e.g., via matching engine 144) may generate one or more proposed actions based on one or more indications from the plurality of user devices 132 via the additional user tools. The matching engine 144 may perform matching operations to pair orders from opposite sides based on time priority, where the order that was activated first has the highest priority. In some examples, upsizing or downsizing an order may not change the priority of the order. In some examples, one or more of cancelling an active order, changing sides, or adding size to a fully matched order may reset the priority of the order. The matching engine 144 may enforce matching rules that require the same price type for orders to generate a match, such that if a credit has a volume clearing level with both spread and price, only orders of the same price type may be matched. The matching engine 144 may further enforce entity-based matching rules that prevent traders from the same entity from trading with each other, such that matching may verify that opposite sides are associated with different entities. As orders are matched during the coordination session, the coordination system 102 may display the matched quantity in the volume clearing filled quantity column and update the buy and sell size columns with remaining quantity based on what was activated. The size and direction of orders may not be disclosed to other subscribers, and the coordination system 102 may display a limited amount of information to the marketplace indicating that there is interest in a particular credit using different color schemes. At the conclusion of the coordination session, the coordination system 102 may generate trades on the total matched quantity at the original traded level. In some examples, for spread-based trades, the trade price may be computed based on the current treasury yield and/or as determined by metric calculator 142. The coordination system 102 may transmit trade generation signals and perform credit limit updates (e.g., via an external system 104 and/or to database(s) 116).

At step 640, the coordination system 102 may execute the one or more proposed actions after a completion of the coordination session. At the end of the coordination session, trades may be generated on the total matched quantity at the original traded level. For spread-based trades, the trade price may be computed based on the current treasury yield and/or as determined by metric calculator 142. The coordination system 102 may transmit trade generation signals to finalize the matched orders and perform credit limit updates via an external system (e.g., external system 104). In some examples, the final trade may be shown in a trade blotter, straight-through-processing may be initiated, and/or a countdown timer may be displayed. For credits where there are multiple fills during the coordination session, the trade on the credit may be generated on the total quantity at the conclusion of the coordination session. The coordination system 102 may update a staging blotter with appropriate status and adjusted filled and remaining quantity information. For orders where the trader added size in the same direction, the order quantity and total filled and remaining quantity and status may be updated after the coordination session is completed. The trade blotter may display all trades filtered by the coordination session protocol identifier to show trades executed during the coordination session, and users may be permitted to export trades from the trade blotter.

One or more features or steps performed by the system may be implemented using an application programming interface (API). An API may define one or more parameters that are passed between a calling application and other software code (e.g., an operating system, library routine, function) that provides a service, that provides data, or that performs an operation or a computation.

Components of the system of the present disclosure may be embodied on a single computing device. In other examples, components of the system may be embodied on two or more computing devices distributed over several physical locations, connected by one or more wired and/or wireless links. It should be understood that the system of the present disclosure refers to a computing system having sufficient processing and memory capabilities to perform the specialized functions described herein.

Some portions of the present disclosure describe examples in terms of algorithms and/or routines and symbolic representations of operations on information. These algorithmic descriptions and representations are used to convey the substance of this disclosure effectively to others skilled in the art. These operations, while described functionally, computationally, or logically, are to be understood as being implemented by data structures, computer programs or equivalent electrical circuits, field programmable gate arrays (FPGAs), microcode, or the like. Furthermore, at times, it may be convenient to refer to these arrangements of operations as routines or algorithms. The described operations and their routines/algorithms may be embodied in specialized software, firmware, specially-configured hardware or any combinations thereof.

The methods described herein may be performed by processing logic that may comprise hardware (e.g., circuitry, dedicated logic, programmable logic, microcode, etc.), software (such as instructions run on a processing device), or a combination thereof. In one embodiment, the methods described herein may be performed by one or more specialized processing components.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some examples, computers may comprise processors, memories, data storage devices, and/or other commonly known or novel components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. It will be understood by those of ordinary skill that connections between computers may be wired in some cases (e.g., via wired TCP connection or other wired connection) or may be wireless (e.g., via a WiFi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

Referring now to FIG. 7, a functional block diagram of a machine in the example form of computer system 700 within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, one or more of components may be implemented by a specialized machine, particularly programmed to perform certain functions, such as the example machine shown in FIG. 7 (or a combination of two or more of such machines). In some examples, one or more of components 112-128 and 140-144 of the coordination system 102, the one or more external systems 104, the one or more order systems 106 and the one or more user devices 132 may be implemented by a specialized machine, particularly programmed to perform certain functions, such as the example machine shown in FIG. 7 (or a combination of two or more of such machines).

The example computer system 700 may include processing device 702, memory 706, data storage device 710 and communication interface 712, which may communicate with each other via data and control bus 718. In some examples, computer system 700 may also include display device 714 and/or user interface 716.

Display device 714 may be any known display technology, including but not limited to display devices using Liquid Crystal Display (LCD) or Light Emitting Diode (LED) technology.

The processing device 702 may use any known processor technology, including but not limited to graphics processors and multi-core processors. The processing device 702 may include, without being limited to, a microprocessor, a central processing unit, an application-specific integrated circuit (ASIC), a field programmable gate array (FPGA), a digital signal processor (DSP) and/or a network processor. The processing device 702 may be configured to execute processing logic 704 for performing the operations described herein. The processing device 702 may include a special-purpose processing device specially programmed with processing logic 704 to perform the operations described herein.

The memory 706 may include, for example, without being limited to, at least one of a read-only memory (ROM), a random access memory (RAM), a flash memory, a dynamic RAM (DRAM) and a static RAM (SRAM), storing computer-readable instructions 708 executable by processing device 702. The memory 706 may include a non-transitory computer readable storage medium storing computer-readable instructions 708 executable by processing device 702 for performing the operations described herein. Although one memory 706 is illustrated in FIG. 7, in some examples, computer system 700 may include two or more memory devices (e.g., dynamic memory and static memory).

The user interface 716 may be any known input device technology, including but not limited to a keyboard (including a virtual keyboard), mouse, track ball, camera, and touch-sensitive pad or display.

The data and control bus 718 may be any known internal or external bus technology, including but not limited to industry standard architecture (ISA), extended ISA (EISA), peripheral component interconnect (PCI), PCI Express, universal serial bus (USB), Serial advanced technology attachment (ATA) or FireWire.

The computer system 700 may include communication interface 712, for direct communication with other computers (including wired and/or wireless communication) and/or for communication with a network. In some examples, computer system 700 may include display device 714 (e.g., a liquid crystal display (LCD), a touch sensitive display, etc.).

In some examples, the computer system 700 may include data storage device 710 storing instructions (e.g., software) for performing any one or more of the functions described herein. Data storage device 710 may include a non-transitory computer-readable storage medium, including, without being limited to, solid-state memories, optical media and magnetic media.

One or more features or steps of the disclosed examples may be implemented using an application programming interface (API). An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

The methods described herein, including those with reference to one or more flowcharts, may be performed by a controller and/or processing device (e.g., smartphone, computer, etc.). The methods may include one or more operations, functions, or actions as illustrated in one or more of blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation. Dashed lines may represent optional and/or alternative steps.

Additional examples of the presently described method and device examples are suggested according to the structures and techniques described herein. Other non-limiting examples may be configured to operate separately or may be combined in any permutation or combination with any one or more of the other examples provided above or throughout the present disclosure. Components and/or arrangement of components illustrated in one figure may be incorporated into any other figure.

While the present disclosure has been discussed in terms of certain examples, it should be appreciated that the present disclosure is not so limited. The examples are explained herein by way of example, and there are numerous modifications, variations and other examples that may be employed that would still be within the scope of the present disclosure.

1. A system comprising:
at least one database configured to store one or more first completed actions and one or more requested actions, to form first data; and
at least one server coupled to the at least one database and a plurality of user devices, the at least one server configured to:
initiate a predefined period, and during the predefined period:
broadcast the predefined period to the plurality of user devices,
display, via an interactive GUI, on the plurality of user devices the first data together with user interaction tools for performing one or more first predefined actions associated with the first data,
receive, from the plurality of user devices, a plurality of action indications associated with the one or more first predefined actions for a portion of the first data via the user interaction tools of the interactive GUI,
determine that one or more characteristics associated with the plurality of action indications and the portion of the first data meet one or more predetermined conditions, and
accept those among the plurality of action indications that meet the one or more predetermined conditions to form second data;
initiate, at a completion of the predefined period, a coordination session, and during the coordination session:
display, via the interactive GUI, on the plurality of user devices, the second data and additional user tools for performing one or more second predefined actions associated with the second data, and
generate one or more proposed actions based on two or more of the plurality of action indications from the plurality of user devices via the additional user tools; and
execute the one or more proposed actions after a completion of the coordination session.

2. The system of claim 1, wherein the one or more predetermined conditions include determining a user's status in relation to the first data.

3. The system of claim 1, wherein the generating of the one or more proposed actions comprises:
analyzing the two or more of the plurality of action indications;
matching a pair of the two or more of the plurality of action indications; and
proposing an action for the pair.

4. The system of claim 3, wherein the matching comprises determining a priority among the two or more of the plurality of action indications.

5. The system of claim 1, wherein the one or more second predefined actions includes a change action to change one or more of the plurality of action indications.

6. The system of claim 1, wherein a user identity is anonymous in the plurality of action indications.

7. The system of claim 1, wherein the plurality of user devices is selected by the system.

8. The system of claim 1, wherein the plurality of action indications comprise one or more price improvement indications for one or more actions in the first data.

9. The system of claim 1, wherein the system prohibits entry of additional action indications during the coordination session.

10. The system of claim 1, the at least one server further configured to:
transform, at the completion of the predefined period, the plurality of action indications into a plurality of orders, wherein the generation of the one or more proposed actions is based on the plurality of orders.

11. A method, comprising:
initiating, by at least one processor, a predefined period, and during the predefined period:
broadcasting, by the at least one processor, the predefined period to a plurality of user devices,
displaying, via an interactive GUI, on the plurality of user devices first data together with user interaction tools for performing one or more first predefined actions associated with the first data, the first data comprising one or more first completed actions and one or more requested actions,
receiving, at the at least one processor from the plurality of user devices, one or more action indications associated with the one or more first predefined actions for a portion of the first data via the user interaction tools of the interactive GUI,
determining, by the at least one processor, that one or more characteristics associated with the one or more action indications and the portion of the first data meet one or more predetermined conditions, and
accepting, by the at least one processor, those among the one or more action indications that meet the one or more predetermined conditions to form second data;
initiating, by the at least one processor at a completion of the predefined period, a coordination session, and during the coordination session:
displaying, via the interactive GUI, on the plurality of user devices, the second data and additional user tools for performing one or more second predefined actions associated with the second data, and
generating, by the at least one processor, one or more proposed actions based on one or more indications from the plurality of user devices via the additional user tools; and
executing, by the at least one processor, the one or more proposed actions after a completion of the coordination session.

12. The method of claim 11, wherein the one or more predetermined conditions include determining a user's status in relation to the first data.

13. The method of claim 11, wherein the generating of the one or more proposed actions comprises:
analyzing, by the at least one processor, the one or more indications;
matching, by the at least one processor, a pair of the one or more indications; and
proposing, by the at least one processor, an action for the pair.

14. The method of claim 13, wherein the matching comprises determining a priority among the one or more indications.

15. The method of claim 11, wherein the one or more second predefined actions includes a change action to change one or more of the one or more action indications.

16. The method of claim 11, wherein a user identity is anonymous in the one or more action indications.

17. The method of claim 11, wherein the plurality of user devices is selected by the at least one processor.

18. The method of claim 11, wherein the one or more action indications comprise one or more price improvement indications for one or more actions in the first data.

19. The method of claim 11, further comprising:
prohibiting, by the at least one processor, entry of additional action indications during the coordination session.

20. The method of claim 11, further comprising:
transforming, by the at least one processor at the completion of the predefined period, the one or more action indications into a plurality of orders, wherein the generation of the one or more proposed actions is based on the plurality of orders.

21. A non-transitory computer readable storage medium configured to store one or more programs comprising computer readable instructions that, when executed by a processor, cause the processor to:
initiate a predefined period, and during the predefined period:
broadcast the predefined period to a plurality of user devices,
display, via an interactive GUI, on the plurality of user devices first data together with user interaction tools for performing one or more first predefined actions associated with the first data, the first data comprising one or more first completed actions and one or more requested actions,
receive, from the plurality of user devices, one or more action indications associated with the one or more first predefined actions for a portion of the first data via the user interaction tools of the interactive GUI,
determine that one or more characteristics associated with the one or more action indications and the portion of the first data meet one or more predetermined conditions, and
accept those among the one or more action indications that meet the one or more predetermined conditions to form second data;
initiate, at a completion of the predefined period, a coordination session, and during the coordination session:
display, via the interactive GUI, on the plurality of user devices, the second data and additional user tools for performing one or more second predefined actions associated with the second data, and
generate one or more proposed actions based on one or more indications from the plurality of user devices via the additional user tools; and
execute the one or more proposed actions after a completion of the coordination session.

22. The non-transitory computer readable storage medium of claim 21, wherein the one or more predetermined conditions include determining a user's status in relation to the first data.

23. The non-transitory computer readable storage medium of claim 21, wherein the generating of the one or more proposed actions comprises:
analyzing the one or more indications;
matching a pair of the one or more indications; and
proposing an action for the pair.

24. The non-transitory computer readable storage medium of claim 23, wherein the matching comprises determining a priority among the one or more indications.

25. The non-transitory computer readable storage medium of claim 21, wherein the one or more second predefined actions includes a change action to change one or more of the one or more action indications.

26. The non-transitory computer readable storage medium of claim 21, wherein a user identity is anonymous in the one or more action indications.

27. The non-transitory computer readable storage medium of claim 21, wherein the plurality of user devices is selected by the processor.

28. The non-transitory computer readable storage medium of claim 21, wherein the one or more action indications comprise one or more price improvement indications for one or more actions in the first data.

29. The non-transitory computer readable storage medium of claim 21, wherein the processor prohibits entry of additional action indications during the coordination session.

30. The non-transitory computer readable storage medium of claim 21, wherein the computer readable instructions further cause the processor to:
transform, at the completion of the predefined period, the one or more action indications into a plurality of orders, wherein the generation of the one or more proposed actions is based on the plurality of orders.
